(19) United States
(12) Patent Application Publication
(10) Pub. No.: US 2009/0208204 A1
(43) Pub. Date: Aug. 20, 2009

(54) PASSIVE OPTICAL NETWORK SYSTEM

(76) Inventors: Na Zhang, Beijing (CN); Hideya Yoshiuchi, Beijing (CN)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/248,940

(22) Filed: Oct. 10, 2008

(30) Foreign Application Priority Data
Feb. 20, 2008 (CN) 200810009861.0

(51) Int. Cl. H04B 10/08

(52) U.S. Cl. 398/25

(57) ABSTRACT

A passive optical network system according to the present invention includes an optical network unit and an optical line terminal connected to a plurality of optical network units. The optical line terminal has: an interface which receives from the optical network unit, a logical link assignment request message containing a communication priority for deciding a priority of a communication flow between a source terminal and a destination terminal, from the destination; and a control unit which assigns a logical link identifier for identifying a communication flow to the logical link assignment request message received from the interface and controls the interface so as to communicate with the optical network unit by using the communication priority.

The present application claims priority from Japanese application CN P200810009861.0 filed on Feb. 20, 2008, the content of which is hereby incorporated by reference into this application.

### BACKGROUND OF THE INVENTION

The present invention relates to an optical network system and in particular, to a passive optical network system in which a user can select a communication priority.

Since the passive optical network system (PON) can exhibit a high efficiency at a low cost, it can solve the bottle neck problem in the connection network band. The PON system provides to a user, a high-speed optical fiber user network of a wide band and a long transmission distance. Moreover, the PON system provides a transmission network between a user and a core network. The PON system has a structure of an optical fiber user network as a tree topology structure formed by connecting a plurality of optical network units (ONU) to a single optical network line terminal (OLT).

The IT-T G.983.1 Specifications recommend a PON system having a topology from one point to multiple points and a passive optical splitter structure. The PON system employs a transmission method in which data transmission is different between the upstream and downstream directions. In the downstream direction, the data transmission from an external network to a user is realized by an optical line terminal OLT which performs transmission to a plurality of optical network units ONUs by the broadcast method. Each of the optical network units ONU selectively receives data. On the other hand, in the upstream direction, the data transmission from a plurality of users to the external network is performed by employing the time-division multiplexing method to perform time slot assignment so as to prevent a collision with an upstream signal.

FIG. 15 is a block diagram showing a basic configuration of a PON system network. A PON system 100 is arranged between a network 101 and users 105. The PON system 100 is formed by an optical line terminal 102, a passive optical splitter 103, and a plurality of ONU which are connected by optical fibers.

A gigabit-capable passive optical network system (GPON) is one of the well known PON systems. According to the ITU-U G.984.1, the GPON system provides a bi-directional transfer rate of 2.4 Gbps at maximum. The GPON system has a basic configuration identical to the PON system shown in FIG. 15. In the explanation given below, the PON system 100 is described as the GPON system 100, but the system is not to be limited to the GPON system. Moreover, a logical link identifier is described as a port identifier (Port-IDentifier: Port-ID) in the GPON system.

In the GPON system 100, when each of the users performs communication, data is transferred between OLT 102 and ONU 104. It is necessary to form one or several logical links and distinguish a plurality of data flows. The logical link is called “a port” in the GPON system. Moreover, an identifier, i.e., a 12-bit Port-ID is defined to distinguish the port. The ITU-T G.984.3 Specifications define the Port-ID and specific application.

In the conventional GPON system, a communication flow, i.e., a logical link is uniquely defined by an identifier. However, since in the conventional GPON system, the maximum number of identifiers which are assigned to one optical network unit is set as a predetermined value of the system, a number of users connected to a particular optical network unit cannot exceed the maximum number of the communication partners and the optical network unit identifiers.

Moreover, the ITU-T G.984.3 Specification takes no consideration on a specific method how to assign an identifier. Normally, an identifier is statistically assigned to separate ONU when setting the GPON system and at least one Port-ID is assigned to each ONU. The identifier assigned according to the ONU cannot control a service quality of a different service.

In order to solve the aforementioned problem, US Patent Document Pub. No. 20070025734 “PON system and logical link allocation method” suggests a certain method. More specifically, a PON system is formed by an OLT and at least one ONU. The OLT is connected to the network and the ONU is connected to a user terminal and connected to the OLT by an optical fiber. In the system, instead of deciding the maximum number of the communication flows to the optical network unit, identifiers between optical network unit and the optical line terminal are dynamically set according to a user request. According to this method, the optical network can change the maximum number of the identifiers in accordance with the user needs.

In the aforementioned system, a logical link generation/deletion condition table and a logical link identifier assignment table are used for logical link allocation between the OLT and the ONU. The logical link generation/deletion condition table defines the condition for generating/deleting a logical link according to classification of data or services indicated by the content of the packet passing via the PON system. The logical link management table contains information on the logical links to be assigned. Moreover, addition or deletion of a content to/from the logical link management table is controlled by referencing the logical link generation/deletion condition table. Each time a packet is received, the PON system checks the packet content and assigns an appropriate logical link according to the content.

However, the method disclosed in the US Patent Document Pub. No. 20070025734 suggests only the logical link allocation method in accordance with the service type and takes no consideration on a user. That is, as one of the communication flow features, it is necessary to set a communication priority according to the normal service type. For example, a high priority is set for a sound/image flow while a low priority is set for a data communication such as a mail. However, the service type to which a higher priority is assigned differs depending on a user. For example, some users attach more importance to an image flow while the other users attach more importance to a file download. For this, the conventional method which sets the service type and the communication priority as fixed values cannot satisfy the user individualized desire.

Thus, the conventional PON system has the following problems.

(1) A user should follow the service priority judgment mechanism defined in the GPON system but there is no service priority judgment mechanism based on an individualized user desire.

(2) A user cannot control multiple Port-ID assignment by himself/herself.

### SUMMARY OF THE INVENTION

It is therefore an object of the present invention to provide a PON system in which a user can select a priority and in particular, a priority judgment mechanism individualized by a user so that when a large downstream flow amount exists and a service congestion and data delay are caused, a user can decide the service priority by himself/herself. Moreover, the present invention provides a multiplex logical link identifier filtering mechanism to a user so as to realize multiplex user interface management.

The present invention provides an optical line terminal connected to a plurality of optical network units and controlling communication via a network between a source terminal and a destination terminal connected to the optical network unit. The optical line terminal includes:

an interface which receives from the optical network unit, a logical link assignment request message containing a communication priority deciding a priority of a communication flow between the source terminal and the destination terminal from the destination; and

a control unit which assigns a logical link identifier for identifying a communication flow in accordance with the logical link assignment message received from the interface and controls the interface so as to communicate with the optical network unit by using the communication priority.

Moreover, the present invention provides an optical network unit connected to an optical line terminal for controlling a communication via a network, between a source terminal and a destination terminal connected to the optical network unit. The network unit includes:

an interface which receives from the destination terminal, a logical link assignment request message containing a communication priority for deciding a priority of a communication flow between the source terminal and the destination terminal and transmits the logical link assignment request message to the optical line terminal; and

a control unit which monitors the communication flow transmitted from the source terminal via the network and the optical line terminal according to the logical link identifier and the communication priority transmitted from the optical line terminal and transmits a communication flow corresponding to the logical link identifier to the destination terminal;

wherein the logical link identifier is assigned to the logical link assignment request message in response to the logical link assignment request message received from the interface by the optical line terminal.

Moreover, the present invention provides a client which performs a communication with a source terminal via an optical network unit, an optical line terminal, and a network. The client includes:

an interface which transmits a logical link assignment request message containing a communication priority containing a priority of a communication flow between a source terminal and a destination terminal to the optical line terminal via the optical network unit; and

a control unit which controls the interface so as to receive a communication flow corresponding to the identifier and the communication priority in accordance with the assigned identifier and the communication priority in response to the logical link assignment request message transmitted from the optical line terminal.

Moreover, the present invention provides a passive optical network system including: an optical network unit; and a optical line terminal which are connected to a plurality of optical network units and controls a communication via a network between a source terminal and a destination terminal connected to the optical network unit.

The optical line terminal includes:

an interface which receives from the destination terminal, a logical link assignment request containing a communication priority for deciding a priority of a communication flow between the source terminal and the destination terminal from the destination; and

a control unit which assigns a logical link identifier for identifying a communication flow to the logical link assignment request message received from the interface and controls the interface so as to communicate with the optical network unit by using the communication priority.

The optical network unit includes:

an interface which receives from the destination terminal, a logical link assignment request message containing a communication priority and transmits the logical link assignment request message to the optical line terminal; and

a control unit which monitors the communication flow transmitted from the source terminal via the network and the optical line terminal according to the logical identifier and the communication priority transmitted from the line optical terminal and transmits a communication flow corresponding to the logical link identifier to the destination terminal.

The logical link identifier is assigned to the logical link assignment request message in response to the logical link assignment request message received from the interface by the optical line terminal.

Moreover, the present invention provides a data transfer method in a passive optical network system comprising an optical network unit and an optical line terminal connected to a plurality of optical network units.

A destination terminal connected to the optical network unit transmits a logical link assignment request message containing a communication priority deciding a priority of a communication flow between a source terminal and a destination terminal to the optical line terminal via the network unit.

The optical line terminal assigns a logical link identifier for detecting a communication flow to the logical link assignment request message according to the logical link assignment request message received from the interface and transmits the logical link identifier and the communication priority to the network unit.

The optical network unit monitors the communication flow transmitted via the network and the optical line terminal from the source terminal according to the logical link identifier and the communication priority transmitted from the optical line terminal and transmits a communication flow corresponding to the logical link identifier to the destination terminal.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing a configuration of an optical network system according to the present invention.

FIG. 2 is a block diagram showing a configuration of an optical line terminal according to the present invention.

FIG. 3 shows an example of a logical link information management table of the optical line terminal according to the present invention.

FIG. 4 is a block diagram showing a configuration of an optical network unit according to the present invention.

FIG. 5 shows an example of a logical link information management table of the optical network unit according to the present invention.

FIG. 6 is a block diagram showing a configuration of a client according to the present invention.

FIG. 7A is a table showing an example of contents of a service priority management table of a client before causing a service priority request according to the present invention.

FIG. 7B is a table showing an example of contents of the service priority management table of the client after making a service priority request according to the present invention.

FIG. 8 is a block diagram showing main message sequences of the Port-ID assignment method which can be controlled by a user according to the present invention.

FIG. 9 is a flowchart showing the Port-ID assignment process described in the present invention.

FIG. 10 is a flowchart showing the entire data transmission process described in the present invention.

FIG. 11A is a block diagram showing a Port-ID request message format according to the present invention.

FIG. 11B is a block diagram showing a Port-ID request response message format.

FIG. 12 is a block diagram showing an example of a service priority request message format according to the present invention.

FIG. 13 is a block diagram showing function modules of the optical network unit in the GPON system having a multiple Port-ID filter according to the present invention.

FIG. 14 is a flowchart showing the data transmission process in the GPON system having the multiple Port-ID filter according to the present invention.

FIG. 15 is a block diagram showing a basic configuration of the PON system according to the conventional technique.

### DETAILED DESCRIPTION OF THE INVENTION

Description will now be directed to preferred embodiments of the present invention with reference to the attached drawings and tables so as to clearly show the advantages and characteristics of the present invention. In the drawings, like components are denoted by like reference numerals. It should be noted that the present invention is not to be limited to the embodiments given below but can be varied in various ways.

A gigabit passive optical network system (hereinafter, referred to as a GPON system) is one of the well-known PON systems. In the GPON system, a logical link is called a port and correspondingly, a logical link identifier is referred to as a port number (hereinafter, referred to Port-ID). In description of the present invention, the GPON system is handled as one specific example of the PON system.

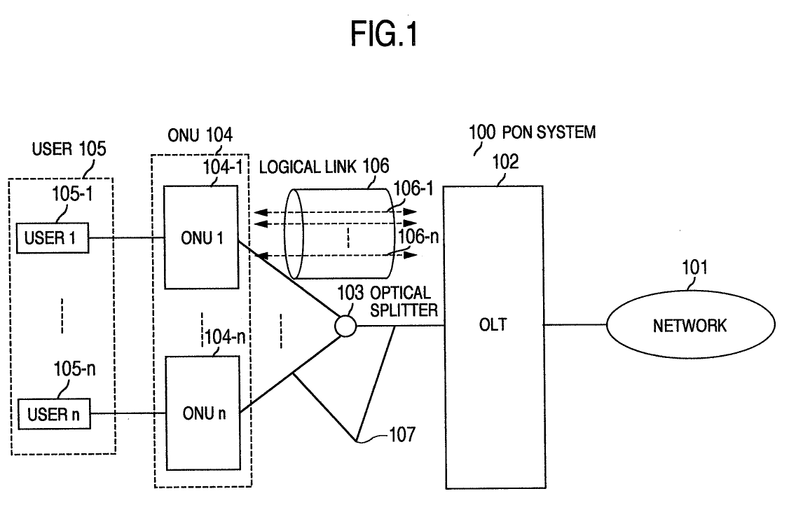

FIG. 1 is a block diagram showing the configuration of the GPON system 100 according to the present embodiment. The GPON system 100 assigns a multiple Port-ID in response to a user request. The GPON system 100 includes an optical line terminal (hereinafter, referred to as OLT) 102, a passive optical splitter 103, and a plurality of optical network units (hereinafter, referred to ONU) 104. The GPON system 100 is arranged between a network 101 and a user (client) 105. The OLT 102 is physically connected to the ONU 104 via an optical fiber 107.

As shown in FIG. 1, a plurality of logical links 106 are arranged between the OLT 102 and the ONU 104 and used for data transmission. The ITU-T G. 984.3 Specifications define the logical link 106 as a Port in the GPON system 100 which is distinguished by the Port-ID and used for multiplexing in a transmission container (T-CONT) of the GPON encapsulation method (GEM) of a plurality of data flows.

The ITU-T G. 984.3 Specifications define the GEM as one of the methods for packaging data in the GPON system. From a viewpoint of a frame structure, the GEM is similar to the other data service encapsulation methods. The T-CONT is a service flow of one group. The Port is a unit to be multiplexed on the T-CONT in the GEM and one T-CONT can be defined as one or more Ports. Data transmission between the OLT and the ONU is performed by the Port. The Port is equivalent to a dummy path/dummy channel in an asynchronous transfer mode (ATM).

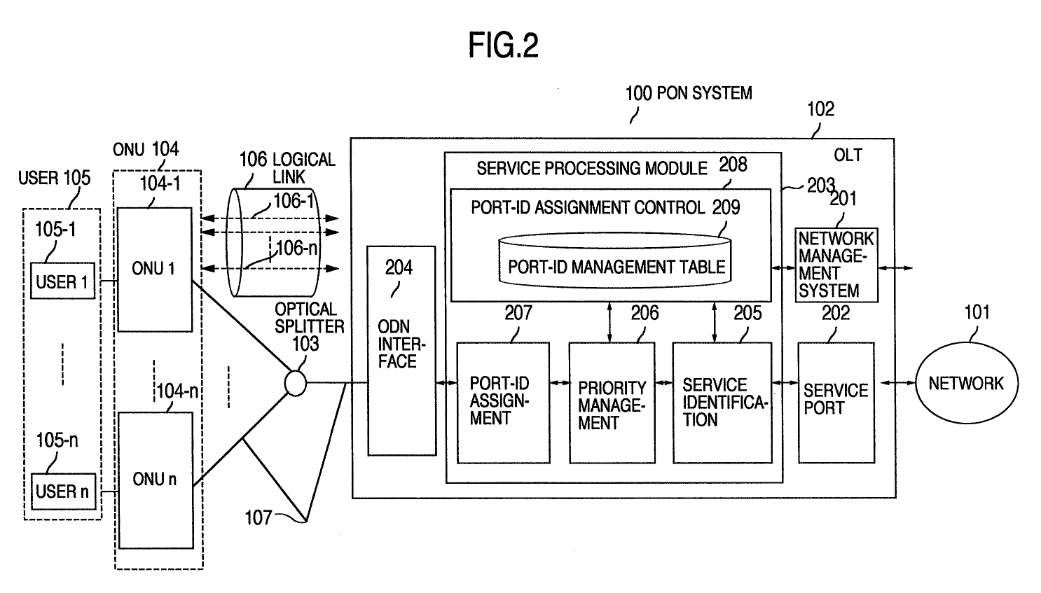

FIG. 2 is a block diagram showing a configuration of the optical line terminal OLT 102 of the GPON system 100. The optical line terminal OLT 102 includes a network management system (NMS) 201, a service port 202, a service processing module 203, an optical division network (ODN) interface 204. Among them, the service processing module 203 has a service detection unit 205, a priority management unit 206, a Port-ID assignment unit 207, and a Port-ID assignment control unit 208. The Port-ID assignment control unit 208 contains a Port-ID management table 209.

The NMS 201 performs system setting for the GPON system 100 including the OLT 102 and the ONU 104 and realizes functions of initialization of the GPON system 100, management of the OLT 102 and the ONU 104, assignment of a network resource, and the like. The service port 202 provides conversion between the service interface of the PON area and the frame interface of the transmission convergence (TC) sub-layer. The service processing module 203 provides functions of framing, media connection control, Operation, Administration, and Maintenance (OAM), Dynamic Bandwidth Assignment (DBA), decision of a protocol data unit boundary, ONU management and intersection layer function, and other TC sub-layer functions. The ODN interface 204 provides a data conversion function to be applied to the data transfer in the ODN.

The service processing module 203 has realized the most of the PON system functions. The service type detection unit 205 listens in a packet which passes and checks the Port-ID management table 209 so as to decide its destination ONU 104. The priority management unit 206 listens in a packet which passes and checks the Port-ID management table 209 so as to decide the class of the Port-ID. The Port-ID assignment unit 207 checks the Port-ID management table 209 so as to decide the Port-ID value.

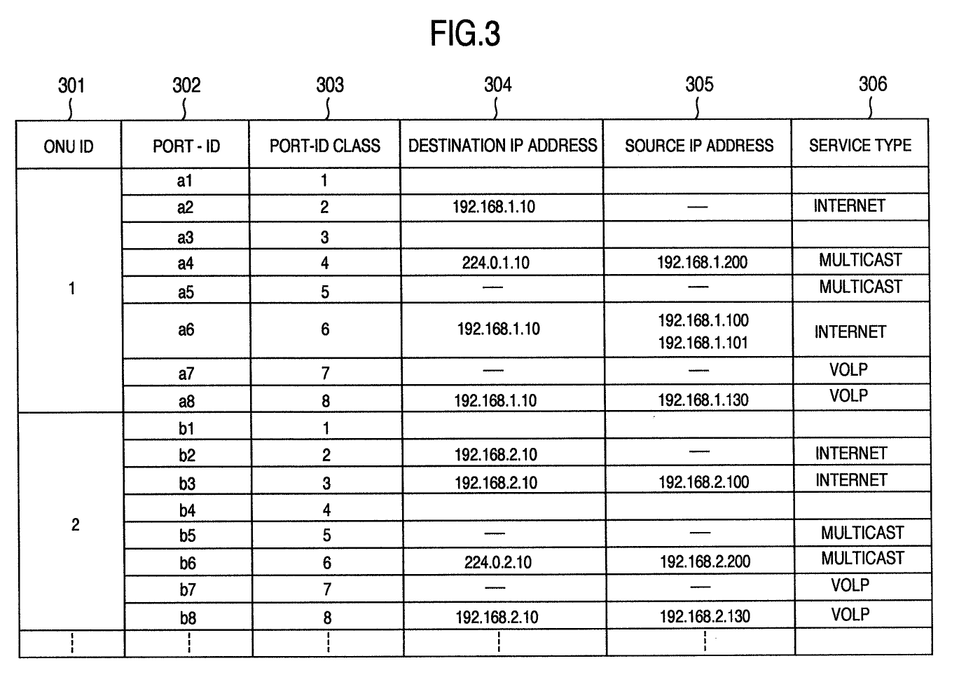

FIG. 3 shows an example of the Port-ID management table 209. The Port-ID management table 209 contains columns of the uniquely specified ONU identifier 301 (ONU III), the Port-ID 302, the Port-ID class 303 indicating each data flow priority, the destination IP address 304 indicating the destination of the packet to be transmitted, the source IP address 305 indicating the source address of the packet to be transmitted, and the service type 306.

The current example assumes that each ONU has eight Port-ID values. Corresponding to this, the Port-ID class 303 has eight values 1 to 8. The priority classes are arranged in the ascending order. That is, 1 is the lowest priority and 8 is the highest priority. In the actual GPON system, the specific number of Port-IDs of each ONU is decided by the system setting.

The service type 306 is information obtained from the second-layer, third-layer, and fourth-layer structure of a packet and the information is used for data type detection of the packet. For example, the data type “Internet” indicates a data communication flow of the Internet; the data type “Voice over IP (VoIP)” indicates an audio service flow; and the data service type “multicast” indicates a communication flow from one point to multiple points which is used for normal video data transmission. For example, a packet having a multicast destination IP address is defined as “multicast”.

Destination IP address 304 and the source IP address 305 are classified into two types: a general IP address and a specific IP address. The specific IP address indicates that a user 105 has a particular priority need for the service. On the contrary, the general IP address in the Port ID management table 209 is expressed by “_” and indicates that a user does not have any specific priority need for the service. The destination IP address 304 is used for judgment of the ONU identifier 301. The source IP address 305 is used for judgment of the Port-ID class 303.

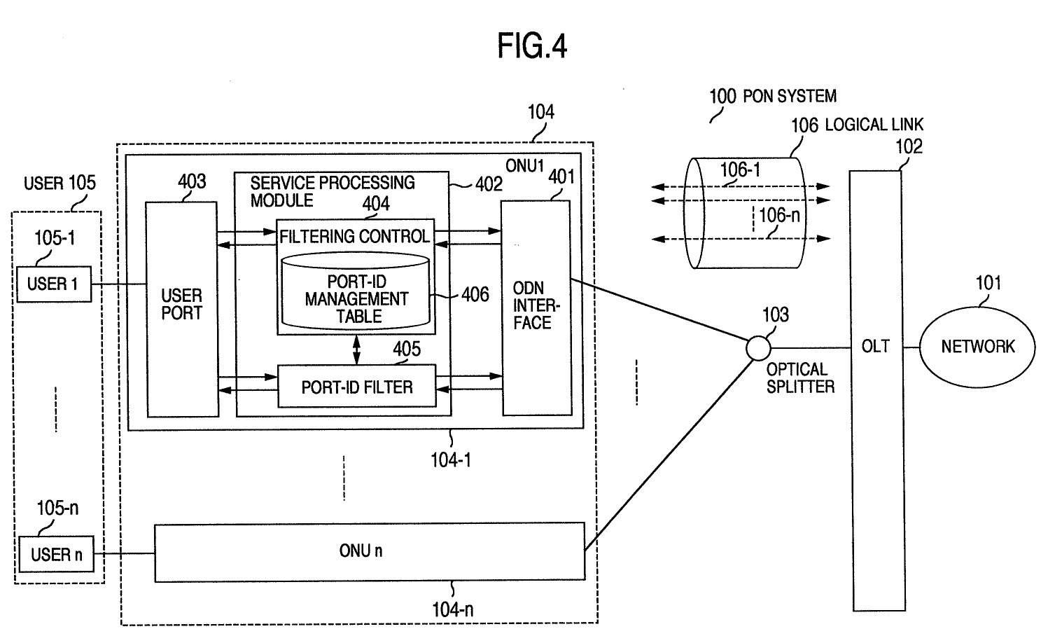

FIG. 4 is a block diagram showing a configuration of the optical network unit ONU 104 of the GPON system. The optical network unit ONU 104 includes an ODN interface 401, a service processing module 402, and a user port 403. Among them, the service processing module 402 has a filtering control unit 404 and a Port-ID filter unit 405.

The ONU 104 has a configuration similar to the configuration of the OLT 102. The function of the ODN interface 401 is identical to the function defined for the ODN interface 404. The user port 403 has an almost identical function to the user port 202 and provides conversion between the PON area user interface and the TC-layer frame interface. Since the ONU 104 processes only one PON interface (or two PON interfaces at the most for protection), the service processing module 203 of the OLT 102 has a comparatively simple structure as compared to the service processing module 402.

A service processing module 403 realizes the most of the functions of the PON system. A Port-ID filter unit 405 receives downstream data, i.e., data transmitted from the OLT 102 to the user 105 and checks the Port-ID management table so as to decide whether to pass or discard the downstream data. A Port-ID management table 406 is similar to the Port-ID management table 209 of the OLT 102. Since the ONU processes only one PON interface (or two PON interfaces at the most for protection), the Port-ID management table 406 manages information such as the Port-ID of only one ONU. A filtering control unit 405 controls update, management, and operation of the Port-ID management table 406.

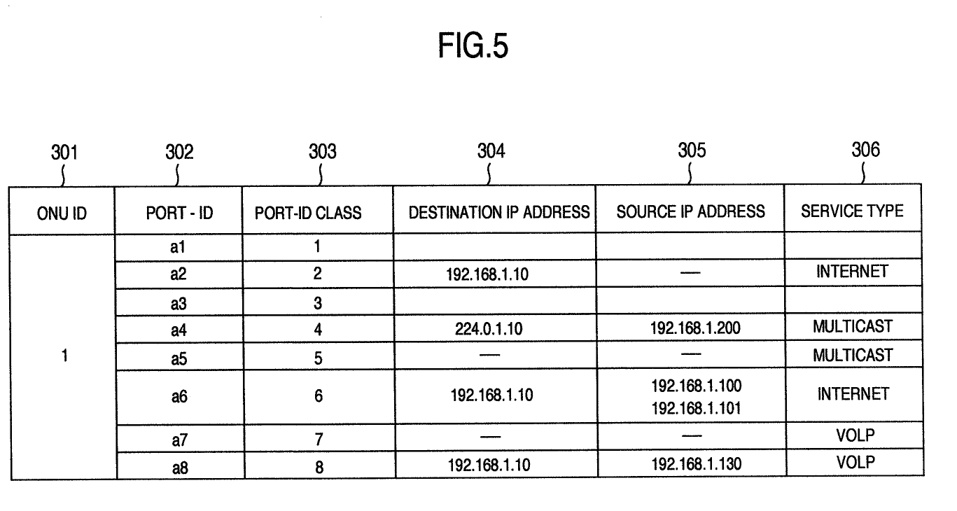

FIG. 5 shows an example of the logical link information management table (Port-ID management table) 406. The Port-ID management table 406 is a part of the Port-ID management table 209. For this, the Port-ID management table 406 has the same contents as the corresponding ONU part of the Port-ID management table 209.

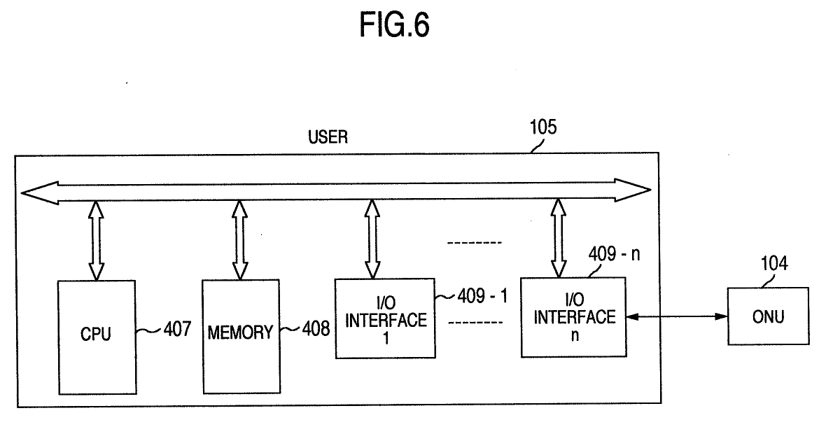

FIG. 6 is a block diagram showing a configuration of a user (client) 105 system. The user 105 system includes a central processing unit (CPU) 407, a memory 408, a plurality of input/output (I/O) interface 409.

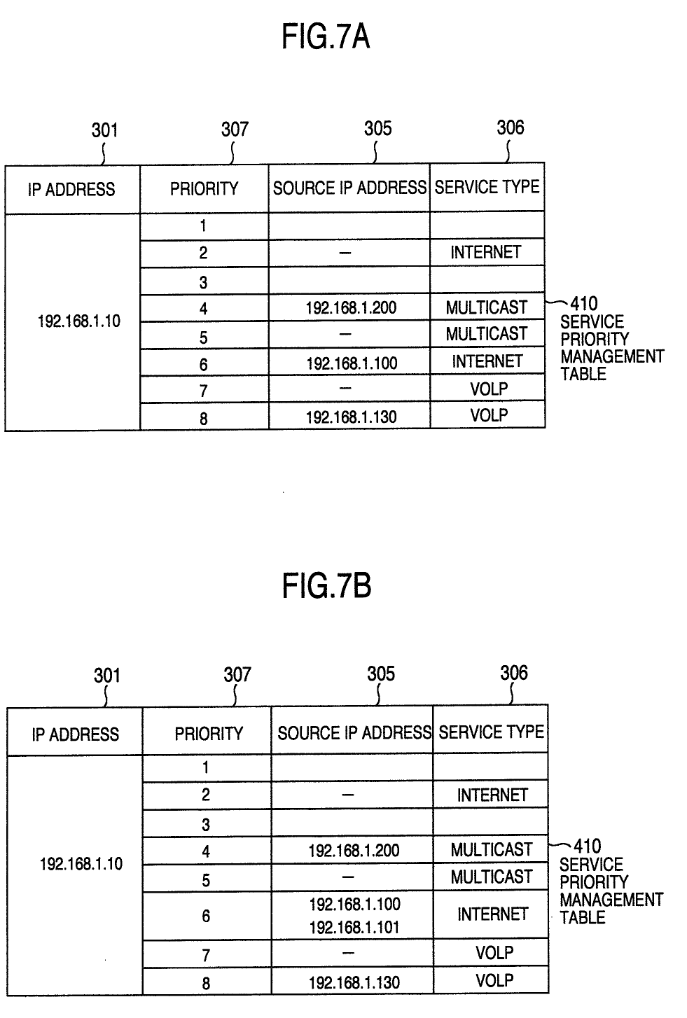

The CPU 407 is a main component of the user 105 and performs calculation and logical calculation. The memory 408 stores data and commands. The I/O interface 409 realizes the function to connect the I/O circuit to the peripheral devices via a system bus. The memory 408 has a service priority management table 410. The service priority management table 410 is detailed in FIG. 7.

FIG. 7A and FIG. 7B show examples of the service priority management table 410 of the user 105. The service priority management table 410 includes the IP address 301, the source IP address 305, the service type 306, and the priority class 307.

FIG. 7A and FIG. 7B show contents of the service priority management table before and after a service priority request is made to the service having the source IP address “1192.168.1.101”. FIG. 7A does not have the source IP address 192.168.1.101 or the corresponding service type and priority. In FIG. 7B, the user makes a service priority request to the service having the source IP address “192.168.1.101”. The service type after the request is “internet” and its priority is 6.

The IP address 307 is the IP address of the user 105 himself/herself and this IP address uniquely identifies the user 105. The source IP address 305 is an IP address of the server side of a specific service or an IP address of the data transmitter. The service type 306 is completely identical to the one defined in the Port-ID management table 209.

The service priority classes 307 are arranged in the ascending order. That is, 1 indicates the lowest priority and 8 indicates the highest priority for a specific service. A particular policy is present for mapping from the service priority class 307 to the Port-ID class 303. However, its detailed explanation is omitted here. If there is a particular mapping mechanism between them, the specific number of the service priority classes 307 may not be identical to the number of the Port-ID classes 303. FIG. 7A and FIG. 7B show examples of 1-to-1 mapping.

When the service priority request message made by a user is replied by the PON system, the Port-ID management table 209 contained in the OLT 102 and the Port-ID management table 406 contained in the ONU 104 simultaneously updates contents of the corresponding source IP address 305 and the service type 306.

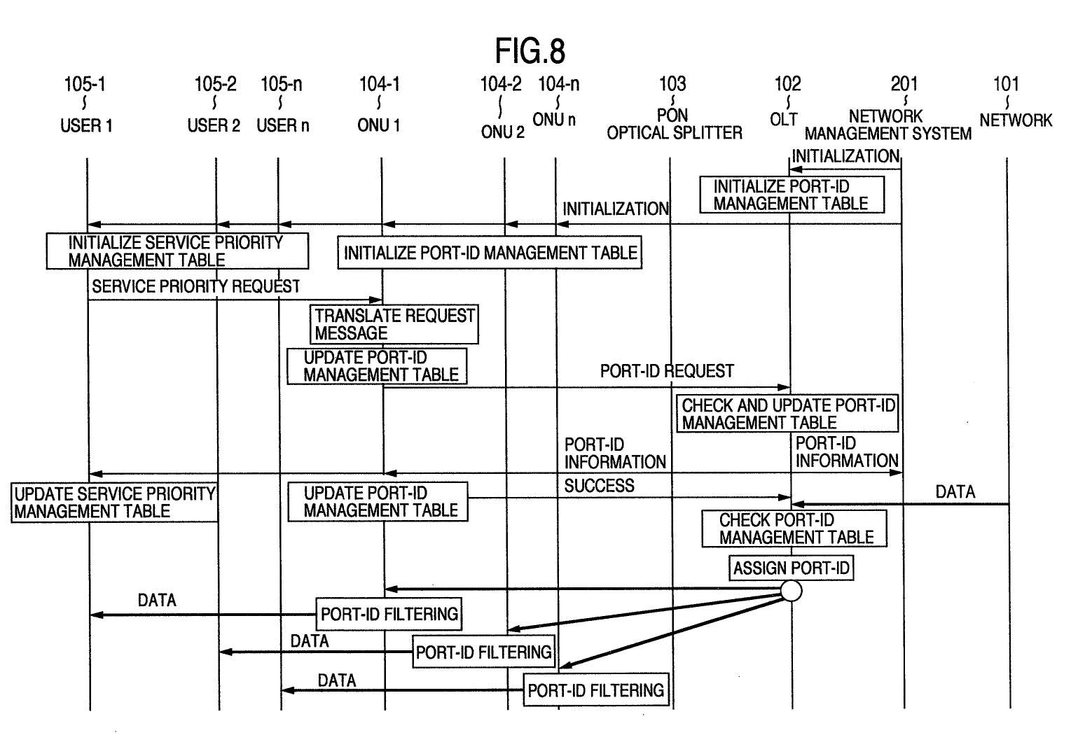

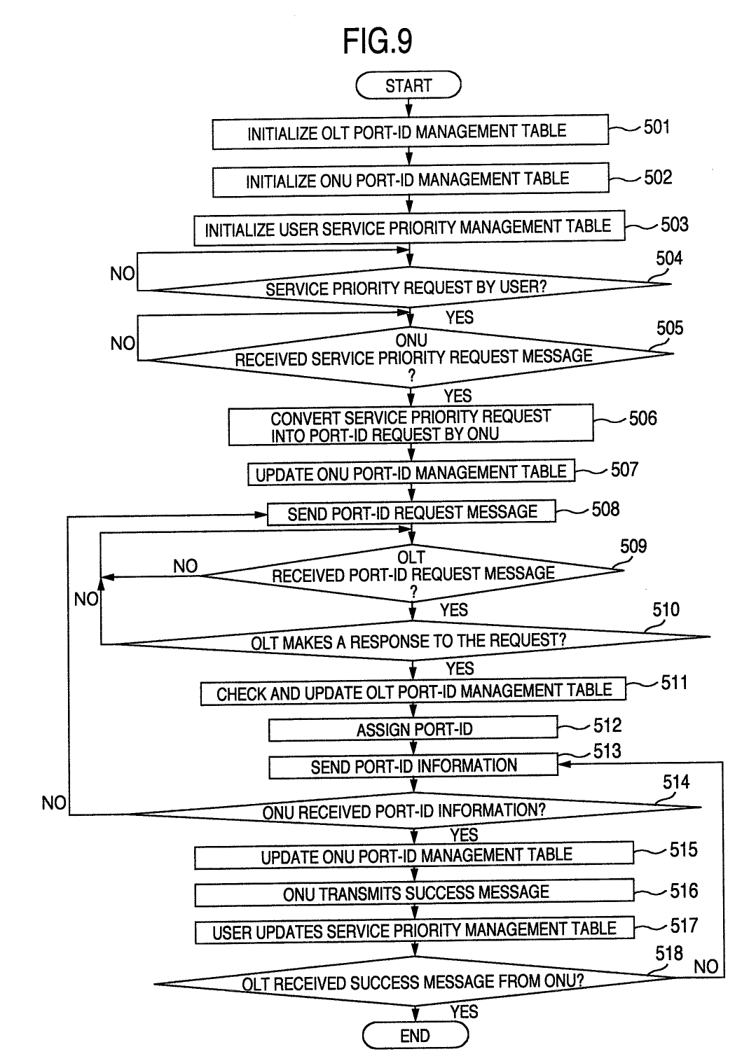

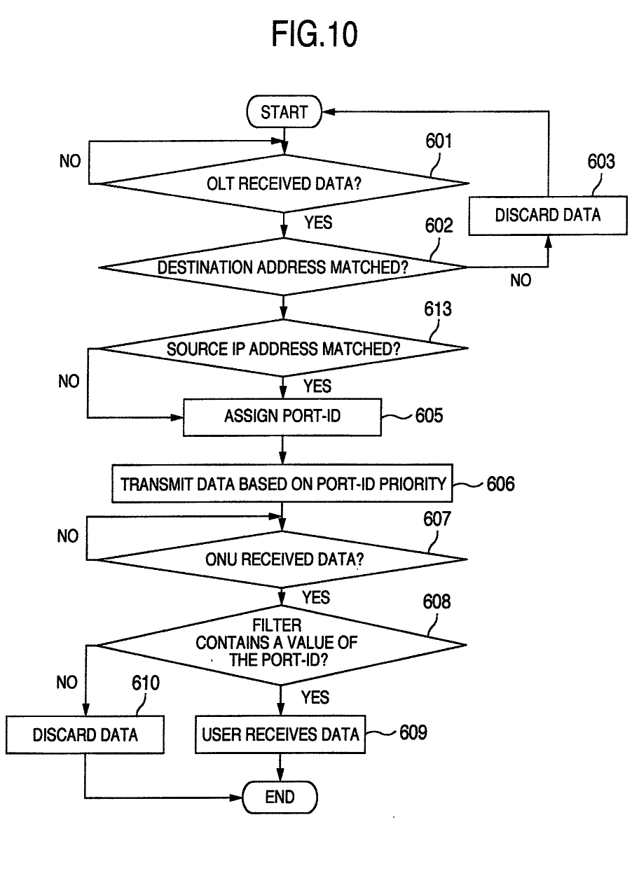

Explanation has been given on the system setting of the Port-ID assignment method which can be controlled by a user in the GPON system. Hereinafter, referring to FIG. 8, FIG. 9, and FIG. 10, a detailed explanation will be given on the Port-ID assignment method which can be controlled by the user.

FIG. 8 shows a main message sequence of the Port-ID assignment method. The OLT 102, the ONU 104, and the user 105 execute initialization via the NMS system 201. That is, the Port-ID management table 209, the Port-ID management table 406, and the service priority management table 410 are initialized.

The ONU 104 listens in the service priority request message from the user 105 and converts the service priority request message into the Port-ID request according to the mapping relationship between the service priority and the Port-ID class described in FIG. 7. The ONU 104 updates the Port-ID management table 406 and transmits the Port-ID request message to the OLT 102.

The OLT 102 listens in the Port-ID request message from the ONU 104 and checks the Port-ID management table 209 so as to decide the Port-ID assignment. The OLT 102 updates the Port-ID management table 209 according to the Port-ID request message received from the ONU 104 and transmits the Port-ID assignment information to the NMS system 201 and the ONU 104.

According to the Port-ID information received from the OLT 102, the ONU 104 updates the Port-ID management table 406, transmits a service priority response message to the user 105, and transmits a success message to the OLT 102 to confirm the reception of the Port-ID message.

The user 105 updates the service priority management table 410 according to the service priority response message transmitted from the ONU 104.

The OLT 102 listens in whether downstream data, i.e., data transmitted from the network 101 to the PON system part is passing. When the downstream data has arrived, the OLT 102 checks of Port-ID management table 209 and assigns an appropriate Port-ID value to the downstream packet. After this, the downstream data is transmitted by the broadcast transmission method in the PON system.

The ONU 104 listens in whether downstream data is passing. When the downstream data arrives, the ONU 104 checks the Port-ID value of the downstream packet so as to perform packet filtering. When the ONU 104 has found a Port-ID value matched with the Port-ID management table 406, the ONU 104 transmits the downstream data to the user 105. Otherwise, the ONU 104 discards the packet.

FIG. 9 is a flowchart showing the Port-ID assignment process described in the present invention. In steps 501, 502, and 503, the OLT 102, the ONU 104, and the user 105 are firstly initialized by the NMS system 201. That is, the Port-ID management table 209, the Port-ID management table 406, and the service priority management table 410 are initialized. After the initialization is completed, ONU ID 301, Port-ID 302, Port-ID class 303, and the default service type 306 in the Port-ID management table 209 and the Port-ID management table 406 are updated and IP address 301, priority 307, source IP address 305, and service type 306 in the service priority management table 410 are updated.

After the initialization, in step 504, the user generates a service priority request message in accordance with a specific need.

In step 505, the ONU 104 checks whether the user 105 transmits the service priority request message. If the user transmits the service priority request message, in step 506 the ONU 104 converts the service priority request message into a Port-ID request message. Moreover, in step 507, the ONU 104 updates Port-ID class 303, destination IP address 304, source IP address 305, and the service type 306 in the Port-ID management table 406. After this, in step 508, the ONU 104 transmits the Port-ID request message to the OLT 102. On the contrary, if the user 105 does not transmit the service priority request message, the ONU 104 keeps listening in a service priority request message from the user 105.

In step 509, the OLT 102 checks whether the ONU 104 transmits the Port-ID request message. If the ONU 104 transmits the Port-ID request message, in step 510 the OLT 102 checks whether to respond to the Port-ID request message. If the OLT 102 has responded to the Port-ID request message, in step 511, the OLT 102 checks the Port-ID management table 209 to judge whether any information matched with the Port-ID is contained and updates Port-ID class 303, the destination IP address 304, and the source IP address 305 in the Port-ID management table. In step 512, the OLT 102 checks the Port-ID management table 209 and assigns the matched Port-ID value. The Port-ID value may be one of the eight values shown in FIG. 3 or a new Port-ID value added. On the contrary, if the ONU 104 does not transmit the Port-ID request message to the OLT 102 in step 509, or if the OLT 102 rejects response to the Port-ID request message in step 510, the OLT 102 keeps listening in a Port-ID request message from the ONU 104.

In step 510, for example, the OLT 102 rejects response to the Port-ID request message from the ONU 104 as follows. Assume that only one user 105 is present for each ONU 104. When the user 105 frequently transmits a service priority request message, the OLT 102 places a predetermined limit on the response to the corresponding Port-ID request message. For example, response is made to only one of the service priority request messages transmitted by the user 105 within a certain time period and no response is made to the other service priority request messages or the response class to the other service priority request is lowered. For example, when the user 105 simultaneously transmits two requests of the service priority 8, the system default priority of the two services are both 4 and the current network state is evaluated. The OLT 102 responds only to the first service priority request and does not respond to the second service priority request. The OLT 102 keeps the service priority 4 of the system default for the second service priority request or lowers the request priority class and responds 6 to the second service priority request. Moreover, when each ONU 104 has two or more than two users 105, a collision may occur if a plurality of users transmit service priority request messages. Accordingly, when the OLT 102 responds to service priority request messages from a plurality of users, the OLT 102 similarly performs a certain limit. For example, in a certain time period, the OLT 102 responds only to a service request message transmitted by a particular user decided by the user priority poling and does not respond to any of the service priority request messages from the other users or lowers the class to respond to the other service priority requests. Thus, it is possible to solve the problem of collision of simultaneous requests from a plurality of users.

In step 513, the OLT 102 transmits information associated with the Port-ID to the NMS system 201 and the ONU 104.

In step 514, the ONU 104 checks whether the Port-ID information transmitted from the OLT 102 has been received. If the ONU 104 has received the Port-ID information transmitted from the OLT 102, the ONU 104 updates the Port-ID management table 406 in step 515 and transmits a success message to the OLT 102 and confirms reception of the information in step 516. Simultaneously with this, in step 517, the user receives the service priority update message transmitted from the ONU 104 and updates the service priority management table 410. On the contrary, if the ONU 104 does not receive the Port-ID information transmitted from the OLT 102, the ONU 104 returns control to step 508 and transmits the original Port-ID request message.

In step 518, the OLT 102 checks whether the ONU 104 has received the success message indicating that the ONU 104 has received the Port-ID information. If the OLT 102 has received the success message, the entire Port-ID assignment process is completed. Otherwise, the OLT 102 returns control to step 513 and again transmits the Port-ID information to the ONU 104.

FIG. 10 is a flowchart showing the entire data transfer process described in the present invention. In step 601, the OLT 102 listens in whether downstream data, i.e., data transmitted from the network 101 to the PON system is passing. If the OLT 102 has received a downstream packet, in step 602, the OLT 102 checks the destination IP address of the packet so as to judge whether a destination IP address 304 matched with the Port-ID management table 209 exists. If Yes, in step 613, the OLT 102 checks the source IP address 303 of the packet and obtains the Port-ID class 303 matched with it. If no source IP address 303 matched with the Port-ID management table 209 exists, in step 613, the OLT 102 checks the service type of the packet and obtains the Port-ID class 303 matched with it.

After this, in step 605, the OLT 102 checks the Port-ID management table 209 and assigns the Port-ID value specified for the packet. In step 606, the packet having the specified Port-ID value is transferred according to its Port-ID class through the logical link 106 of the GPON system 100. That is, when the packet has a Port-ID value of a high priority, it obtains a high priority in the downstream transfer path of the specified ONU 104 without affecting data transfer of the other ONU 104.

On the contrary, in step 602 if no destination IP address 304 matched with it can be found, the OLT 102 discards the packet and starts the entire data transfer process from the beginning.

In step 607, the ONU 104 listens in whether downstream data is passing. If the ONU 104 has received a downstream packet, in step 608, the ONU filter 405 checks whether the Port-ID value of the packet is matched with the value in the Port-ID management table 406. If a Port-ID value 302 matched with the Port-ID value of the packet is contained in the Port-ID management table 406, in step 609, the packet is transferred to the user 105. Otherwise, in step 610, the ONU 104 discards the packet.

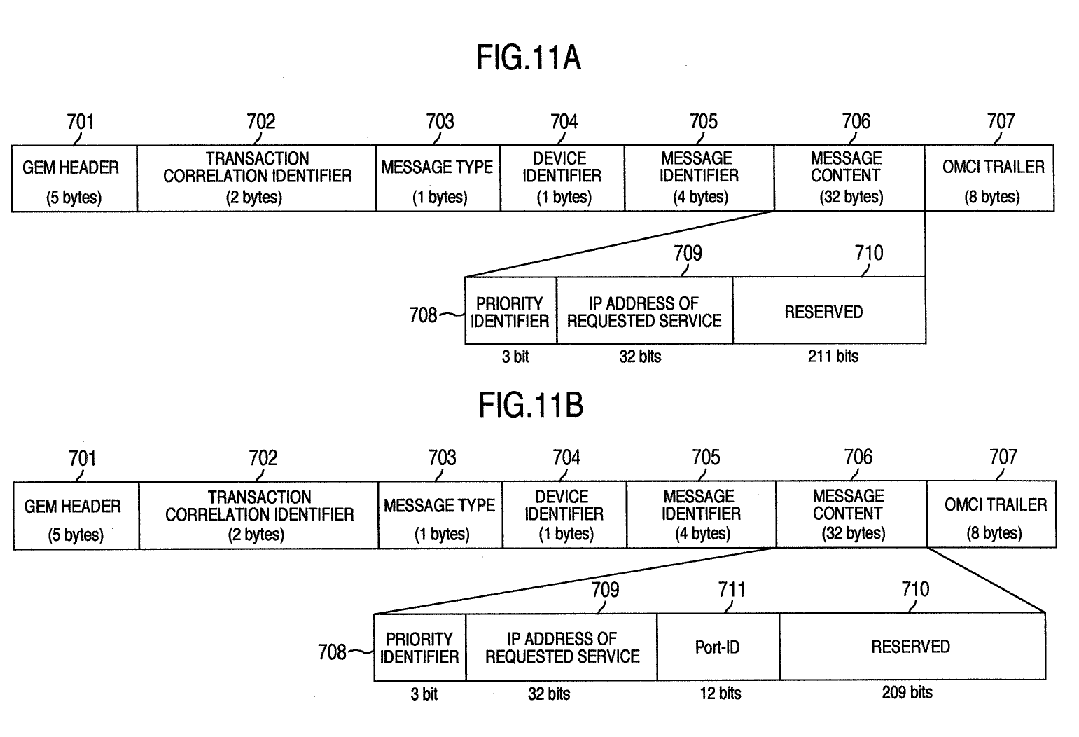

Thus far, explanation has been given on a specific example of the method for assigning a Port-ID which can be controlled by a user. Hereinafter, explanation will be given on a specific example of a Port-ID request and a response message in the GPON system. FIG. 11A and FIG. 11B show formats of a Port-ID request and response message in the GPON system.

The Port-ID request message is realized by Optical Network Terminal (ONT, i.e., an ONU up to a subscriber) management and control interface (OMCI: ONT Management and Control Interface) path in the GPON system. The ITU-T G. 984.3 Specifications describe that the GPON Transmission Convergence (GTC) should provide an OMCI path transfer interface.

FIG. 11A shows a Port-ID request message format. According to the ITU-T G. 984.4 Specifications, the ONT management control protocol packet format contains a GEM header 701, a message content 706, and an OMCI trailer 707.

The GEM header 701 is formed by fixed five bytes of the header portion of the GEM frame. A transaction correlation identifier 702 is used for combination and response of a request message. A message type 703 indicates a specific application type of the message. Here, a special message type for detecting the Port-ID request is defined. According to the ITU-T G. 984.3 Specifications, a device identifier 704 is specified as 0x0A. A message identifier 705 is formed by four bytes. The first two bytes indicate the managed target entity of the specified operation in the message type. The latter two bytes are used to detect a utility of the entity managed. The message content 706 is specified by a specific message. An application of the OMCI trailer 707 is specified by the GPON system.

A particular message type 703 should be provided for the aforementioned Port-ID request message. Moreover, the definition of the specific message content 706 is as follows. The first 3 bits are defined as a priority identifier 708 used for priority judgment. The next 32 bits are defined as an IP address 709 of the requested service, i.e., the source IP address 305 in the Port-ID management table 406. The remaining bits are reserved.

FIG. 11B shows a Port-ID request response message format. Unlike the Port-ID request message, the Port-ID request response message format has additional 12 bits used as a Port-ID area 711. The 12-bit Port-ID value is specified by the OLT 102.

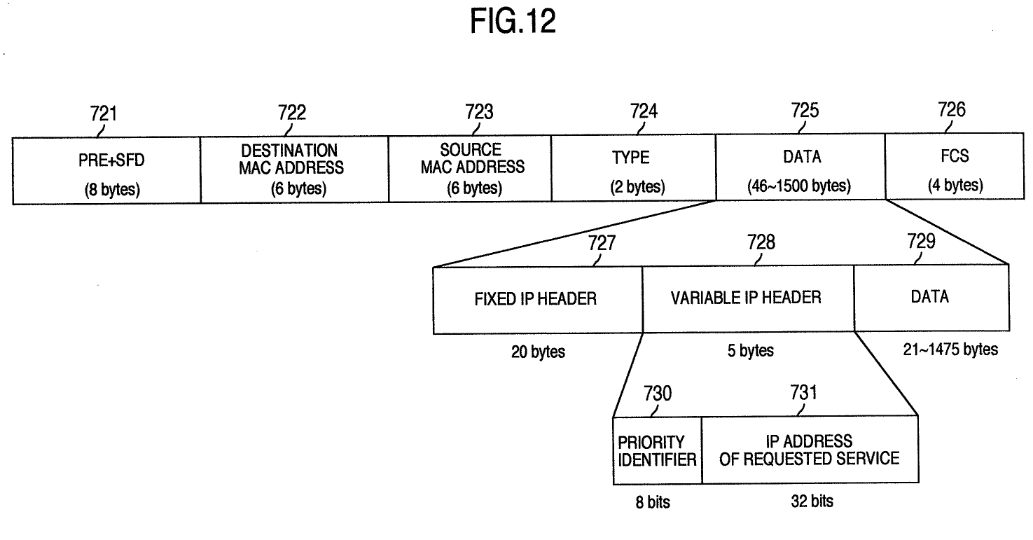

FIG. 12 shows an example of the service priority request message format. The service priority request message format is based on a general Ethernet data frame and formed by a 7-byte preamble (PREE), a 1-byte start frame delimiter (SFD) 721, a 6-byte destination MAC address (DA) 722, a 6-byte source MAC address (SA) 723, 2-byte type information 724, 46- to 1500-byte data 725, and a 4-byte frame check sequence (FCS) 726.

In the data 725, the flexible IP data header transmits the service priority request message containing an 8-bit service priority identifier 730 and a 32-bit request service IP address 731. The IP address of the request service is the source IP address 305 defined in the service priority management table 410. Moreover, the data field portion 725 further contains a fixed 20-byte IP data header 727 and a data region 729 of the IP layer and above.

In FIG. 12, the destination address 722 is the MAC address of the ONU 104 connected to the user, and the source address 723 is the MAC address of the user 105. The service priority request message is defined as a specific type value 724.

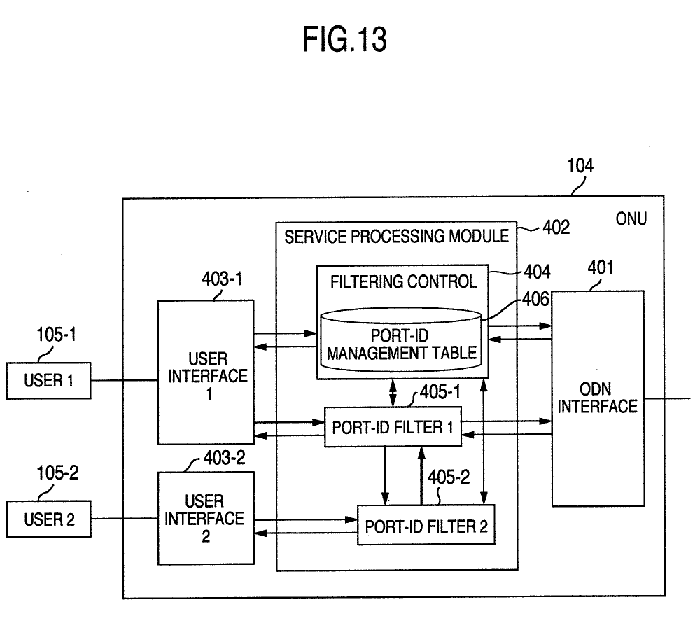

Up to now, by referring to the drawings, explanation has been given on the GPON system according to the present invention and the Port-ID assignment method which can be controlled by a user. Next, referring to FIG. 13, a specific application of the present invention will be explained.

FIG. 13 a block diagram showing function modules of the ONU 104 in the GPON system 100 having a multiple Port-ID filter. As compared to the function module diagram of the ONU 104 in FIG. 4, the multiple Port-ID filter 404, a plurality of user interfaces 403, and a plurality of users 104 are added.

The Port-ID filter 1 405-1 and the Port-ID filter 2 405-2 have a multiple Port-ID filtering function. All the data having the Port-ID values in the Port-ID management table 406 can pass through the filtering by the Port-ID filter 1 405-1 but only some of the data having the Port-ID value in the Port-ID management table 406 can pass through the filtering by the Port-ID filter 2 405-2. That is, as compared to the user interface 1 403-1, the user interface 2 403-2 has a limited right and can receive only a part of data which has passed through the ONU 104. For example, when it is defined that the Port-ID filter 2 405-2 can pass only data of the Port-ID class 4 or above, the user 2 105-2 can receive only a part of data of the Port-ID class 4 or above which has passed through the ONU 104.

Accordingly, the user interface 1 403-1 can be defined as a main user interface. Moreover, the user 105-1 can manage the Port-ID assignment by the user interface 1 403-1. On the other hand, the user interface 2 403-2 can be defined as a sub user interface having a limited data transmission right.

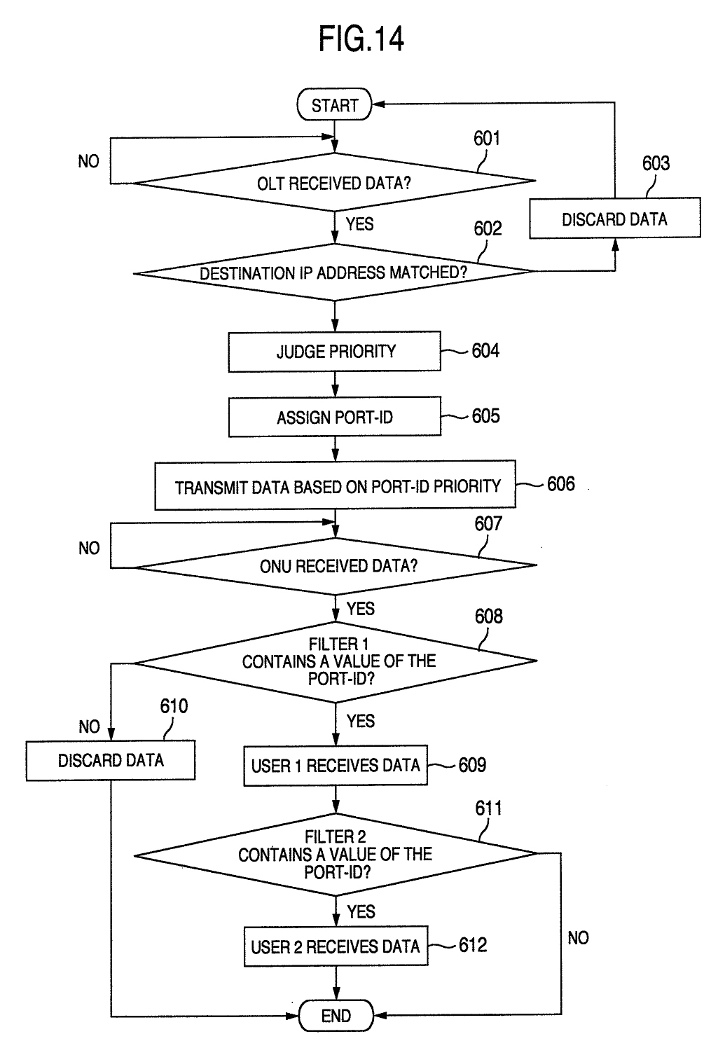

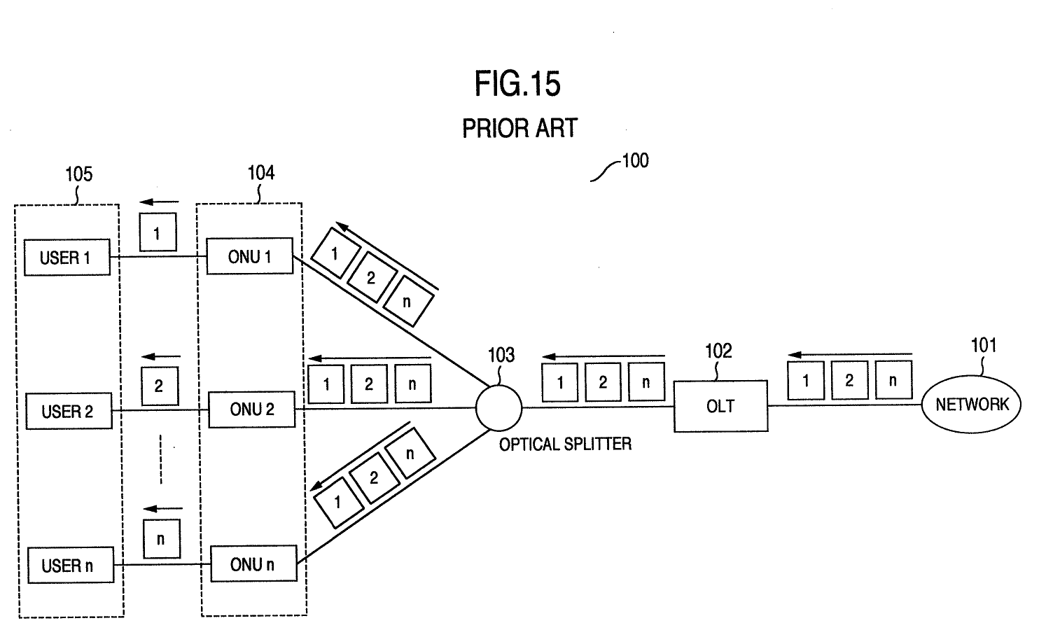

FIG. 14 is a flowchart showing the data transfer process in the GPON system having a multiple Port-ID filter. As compared to FIG. 10, FIG. 14 has a main difference that the user 1 105-2 has step 611 and step 612 for judging whether the user 1 105-2 can receive the data which has passed through the ONU 104. In step 611, the Port-ID filter 2 405-2 checks the Port-ID of the downstream data which has passed through the Port-ID filter 1 405-1. If the Port-ID class is 4 or above, in step 612, the downstream data is transferred to the user 2 105-2. Otherwise, i.e., if the Port-ID class is smaller than 4, the downstream data is not transferred to the user 2 105-2.

According to the present invention, the Port-ID assignment management can be controlled by a user himself/herself. That is, the user can decide the service priority level. Thus, an individualized priority judgment mechanism is provided to each user.

It should be further understood by those skilled in the art that although the foregoing description has been made on embodiments of the invention, the invention is not limited thereto and various changes and modifications may be made without departing from the spirit of the invention and the scope of the appended claims.

1. An optical line terminal connected to a plurality of optical network units and controlling communication via a network between a source terminal and a destination terminal connected to an optical network unit, the optical line terminal comprising:
an interface which receives from the optical network, a logical link assignment request message containing a communication priority deciding a priority of a communication flow between the source terminal and the destination terminal from the destination; and
a control unit which assigns a logical link identifier for identifying a communication flow in accordance with the logical link assignment message received from the interface and controls the interface so as to communicate with the optical network unit by using the communication priority.

2. The optical line terminal as claimed in claim 1, further comprising a logical link information management table for managing the communication flow and the logical link identifier,
wherein the logical link assignment request message contains a source address and a destination address of the communication flow,
the logic link information management table contains the logical link identifier, the source address and the destination address contained in the logical link assignment request message, and the communication priority, and
the control unit controls the interface so as to communicate with the optical network unit by using the communication priority in the logical link information management table.

3. The optical line terminal as claimed in claim 1, wherein the control unit of the optical line terminal assigns a logical link identifier for identifying the communication flow to the logical link assignment request message then updates the logical link information management table and transmitting the logical link identifier assigned for the logical link to the optical network unit.

4. The optical line terminal as claimed in claim 1, wherein if a plurality of logical link assignment request messages are simultaneously received from one client of the optical network units, a logical link identifier is assigned only to one of the logical link assignment request messages in response to the message and no response is executed to the other logical link assignment request messages or the class of the priority of the other logical link assignment request messages is lowered.

5. The optical line terminal as claimed in claim 1, wherein if a plurality of logical link assignment request messages are simultaneously received from a plurality of clients of the optical network units, a logical link identifier is assigned only to one of the logical link assignment request messages in response to the message and no response is executed to the other logical link assignment request messages or the class of the priority of the other logical link assignment request messages is lowered.

6. The optical line terminal as claimed in claim 1, wherein the optical line terminal monitors a packet from the source terminal,
if the logical link information management table contains an address corresponding to the destination of the packet, the optical line terminal assigns a corresponding logical link identifier and a communication priority to the packet in accordance with the logical link information management table, and
if the logical link information management table contains no address corresponding to the destination of the packet, the optical line terminal discards the packet.

7. The optical line terminal as claimed in claim 6, when a corresponding communication priority is assigned to the packet in accordance with the logical link information management table, the corresponding priority is acquired by checking the source address of the packet and
when the logical link information management table contains no corresponding source address, the corresponding communication priority is acquired by checking the service type of the packet.

8. An optical network unit connected to an optical line terminal for controlling a communication via a network between a source terminal and a destination terminal connected to the optical network unit, the network unit comprising:
an interface which receives from the destination terminal, a logical link assignment request message containing a communication priority for deciding a priority of a communication flow between the source terminal and the destination terminal and transmits the logical link assignment request message to the optical line terminal; and
a control unit which monitors the communication flow transmitted from the source terminal via the network and the optical line terminal according to the logical link identifier and the communication priority transmitted from the optical line terminal and transmits a communication flow corresponding to the logical link identifier to the destination terminal;
wherein the logical link identifier is assigned to the logical link assignment request message in response to the logical link assignment request message received from the interface by the optical line terminal.

9. The optical network unit as claimed in claim 8, further comprising a logical link information management table for managing a communication flow and the logical link identifier;
wherein the logical link assignment request message contains a source address and a destination address of the communication flow;
the logical link information management table contains: the logical link identifier; the source address and the destination address contained in the logical link assignment request message; and the communication priority; and
the control unit of the optical network unit performs communication with the destination terminal by using the communication priority contained in the logical link information management table.

10. The optical network unit as claimed in claim 8, wherein the optical network unit receives a logical link identifier for marking a communication flow which has been assigned to the logical link assignment request message from the optical line terminal and updates the logical link information management table before transmitting the logical link identifier to the destination terminal.

11. The optical network unit as claimed in claim 8, wherein the optical network unit monitors a packet from the optical line terminal,
if the logical link information management table contains an identifier corresponding to the logical identifier assigned to the packet, the optical network unit transmits a packet corresponding to the assigned logical link identifier to the destination terminal in accordance with the logical link information management table, and
if the logical link information management table contains no identifier corresponding to the logical identifier assigned to the packet, the optical network unit discards the packet.

12. A client which performs a communication with a source terminal via an optical network unit, an optical line terminal, and a network, the client comprising:
an interface which transmits a logical link assignment request message containing a communication priority containing a priority of a communication flow between a source terminal and a destination terminal to the optical line terminal via the optical network unit; and
a control unit which controls the interface to transmit a logical link assignment request message containing a communication priority.

13. A passive optical network system comprising:
an optical network unit; and a optical line terminal which are connected to a plurality of optical network units and controls a communication via a network between a source terminal and a destination terminal connected to the optical network unit,
wherein the optical line terminal includes:
an interface which receives from the destination terminal, a logical link assignment request containing a communication priority and transmits the logical link assignment request message to the optical line terminal; and
a control unit which assigns a logical link identifier for identifying a communication flow to the logical link assignment request message received from the interface and controls the interface so as to communicate with the optical network unit by using the communication priority; and
the optical network unit includes:
an interface which receives from the destination terminal, a logical link assignment request message containing a communication priority and transmits the logical link assignment request message to the optical line terminal; and
a control unit which monitors the communication flow transmitted from the source via a network and the optical line terminal according to the logical identifier and the communication priority transmitted from the line optical terminal and transmits a communication flow corresponding to the logical link identifier to the destination terminal; and
the logical link identifier is assigned to the logical link assignment request message in response to the logical link assignment request message received from the interface by the optical line terminal.

14. A data transfer method in a passive optical network system comprising an optical network unit and an optical line terminal connected to a plurality of optical network units;
wherein a destination terminal connected to the optical network unit transmits a logical link assignment request message containing a communication priority deciding a priority of a communication flow between a source terminal and a destination terminal to the optical line terminal via the network unit;
the optical line terminal assigns a logical link identifier for detecting a communication flow to the logical link assignment request message according to the logical link assignment request message received from the interface and transmits the logical link identifier and the communication priority to the network unit; and
the optical network unit monitors the communication flow transmitted via the network and the optical line terminal from the source according to the logical link identifier and the communication priority transmitted from the optical line terminal and transmits a communication flow corresponding to the logical link identifier to the destination terminal.

15. A data transfer method in an optical line terminal which is connected to a plurality of optical network units and controls a communication via a network between a source terminal and a destination terminal connected to the optical network unit; the method comprising steps of:
receiving from the optical network unit a logical link assignment request message from the destination terminal, containing a communication priority for deciding a priority of a communication flow between the source terminal and the destination terminal; and
assigning a logical link identifier for identifying the communication flow to the logical link assignment message received from the interface and controlling the interface so as to communicate with the optical network unit by using the communication priority.

16. A data transfer method in an optical network unit which is connected to an optical line terminal and controls a communication via a network between a source terminal and a destination terminal connected to the optical network unit, the method comprising steps of:
receiving from the destination terminal, a logical link assignment request message containing a communication priority for deciding a priority of a communication flow between the source terminal and the destination terminal and transmitting the logical link assignment request message to the optical line terminal; and
monitoring a communication flow transmitted via the network and the optical line terminal from the source according to the logical link identifier and the communication priority transmitted from the optical line terminal and transmitting a communication flow corresponding to the logical link identifier to the destination terminal;
wherein the logical link identifier is assigned to the logical link assignment request message in response to the logical link assignment request message received from the interface by the optical line terminal.
